(19) United States
(12) Patent Application Publication
(10) Pub. No.: US 2015/0195879 A1
(43) Pub. Date: Jul. 9, 2015

(54) ELECTRONIC DEVICE WITH A POWER NOTIFICATION FUNCTION

(71) Applicant: BUNGBUNGAME INC., Taipei City (TW)

(72) Inventor: San-Tai Hsu, Taipei City (TW)

(73) Assignee: BUNGBUNGAME INC., Taipei City (TW)

(21) Appl. No.: 14/264,061

(22) Filed: Apr. 29, 2014

(30) Foreign Application Priority Data
Jan. 6, 2014 (TW) 103100441

(51) Int. Cl. H05B 33/08

(52) U.S. Cl. CPC H05B 33/0842

(57) ABSTRACT

The present invention discloses an electronic device including a casing, a light emitting module, a light penetrating portion, a battery module and a control module. The light emitting module and the battery module are disposed inside the casing. Light emitted from the light emitting module can penetrate through the light penetrating portion. The control module is disposed inside the casing and electrically connected to the battery module and the light emitting module. As an external electrical power supply charges the battery module, the control module is for controlling the light emitting module to emit different light to pass through the light penetrating portion and outside the casing according to a capacity ratio of a current electrical capacity to a full electrical capacity of the battery module, so as to generate different notification messages corresponding to the current electrical capacity of the battery module.

### BACKGROUND OF THE INVENTION

1. Field of the Invention

The present invention relates to an electronic device, and more specifically, to an electronic device with an instant power notification function.

2. Description of the Prior Art

A conventional electronic device often has a small LED disposed inside a hole on a casing. As the electronic device is charged, the LED only emits light without any variation to notify a user that the electronic device is in a charging state. However, the electronic device has a monotonous appearance in this configuration and cannot notify the user of an electrical capacity of the electronic device by the light with variations. Moreover, when the electronic device, such as a smartphone, is charged, the processor of the smartphone can control a screen of the smartphone to show the electrical capacity to notify the user. However, when the smartphone standbys or the screen of the smartphone is turned off, the smartphone cannot immediately notify the user of the charging state, and the user has to wake up the screen to show the charging state, resulting in inconvenience of operation. Therefore, it is an important issue to design an electronic device capable of notifying the user of the charging state immediately.

### SUMMARY OF THE INVENTION

The present invention is to provide an electronic device capable of notifying a user of the charging state immediately, to solve the above problems.

According to the disclosure, an electronic device includes a casing, a light emitting module, a light penetrating portion, a battery module and a control module. The light emitting module and the battery module are disposed inside the casing. Light emitted from the light emitting module can penetrate through the light penetrating portion. The control module is disposed inside the casing and electrically connected to the battery module and the light emitting module. As an external electrical power supply charges the battery module, the control module is for controlling the light emitting module to continuously emit different light to pass through the light penetrating portion and outside the casing according to a capacity ratio of a current electrical capacity to a full electrical capacity of the battery module, so as to generate different notification messages corresponding to the current electrical capacity of the battery module.

According to the disclosure, the external electrical power supply charges the battery module by a cable or wireless.

According to the disclosure, the light penetrating portion is a text pattern or a graphic pattern.

According to the disclosure, the light emitting module comprises a plurality of light emitting components arranged in a text pattern or a graphic pattern, and the control module is for controlling different numbers of the plurality of light emitting components to emit light to pass through the light penetrating portion and outside the casing according to the capacity ratio.

According to the disclosure, the notification message is a flashing message with a flashing frequency corresponding to the capacity ratio.

According to the disclosure, as the capacity ratio corresponds to a low capacity ratio, the control module is for controlling the light emitting module to emit the flashing message with a low flashing frequency, and as the capacity ratio increases gradually, the control module gradually increases the flashing frequency according to the increasing capacity ratio.

According to the disclosure, the notification message is a bright message with brightness corresponding to the capacity ratio.

According to the disclosure, as the capacity ratio corresponds to a low capacity ratio, the control module is for controlling the light emitting module to emit the bright message with low brightness, and as the capacity ratio increases gradually, the control module gradually increases the brightness according to the increasing capacity ratio.

According to the disclosure, as the current electrical capacity is the full electrical capacity and the battery module is electrically connected to the external electrical power supply, the control module is for controlling the light emitting module not to emit the light or to emit continuous light selectively.

According to the disclosure, as the electronic device is turned off or standby and the battery module is electrically connected to the external electrical power, the control module is for controlling the light emitting module to emit the notification message.

According to the disclosure, a hole is formed on the casing, and the light penetrating portion is disposed inside the hole.

According to the disclosure, the electronic device further includes a protecting layer disposed on the casing. The protecting layer is made of a transparent material, and the light penetrating portion includes a first penetrating area in the casing and a second penetrating area in the protecting layer.

According to the disclosure, the light penetrating portion comprises a first penetrating area in the casing and a second penetrating area on a cover of the light emitting module.

The control module in the present invention is designed to continuously control the light emitting module to emit the light with variable frequency or variable brightness whenever the external power supply charges the battery module, so as to generate the different notification messages to notify the user of current electrical capacity. Therefore, it solves the conventional problems that the user has to wake up the screen of the electronic device to show the charging state. In addition, the control module can also be designed not to control the light emitting module to emit the light when the external power supply does not charge the battery module. Moreover, the color of the light penetrating portion can be designed to be the same with or similar with the color of the casing, so that the text pattern or the graphic pattern formed by the light penetrating portion is not presented as the light emitting module does not emit the light, so as to maintain uniformity of the overall appearance of the electronic device. As a result, it also solves the conventional problem that the LED disposed in a hole on the casing affects uniformity of the overall appearance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating that an electronic device is being charged according to an embodiment of the present invention.

FIG. 2 is a block diagram of the electronic device electrically connected to an external power supply according to the embodiment of the present invention.

FIG. 3 is a partial diagram of the electronic device according to the embodiment of the present invention.

FIG. 4 is a sectional view of the electronic device along a line X-X′ in FIG. 3 according to the embodiment of the present invention.

FIG. 5 is a sectional view of the electronic device according to another embodiment of the present invention.

FIG. 6 is a diagram of an electronic device according to another embodiment of the present invention.

FIG. 7 and FIG. 8 are respectively a diagram and a top view of an electronic device according to another embodiment of the present invention.

FIG. 9 is a diagram illustrating that the external power supply is not connected to the electronic device according to the embodiment of the present invention.

### DETAILED DESCRIPTION

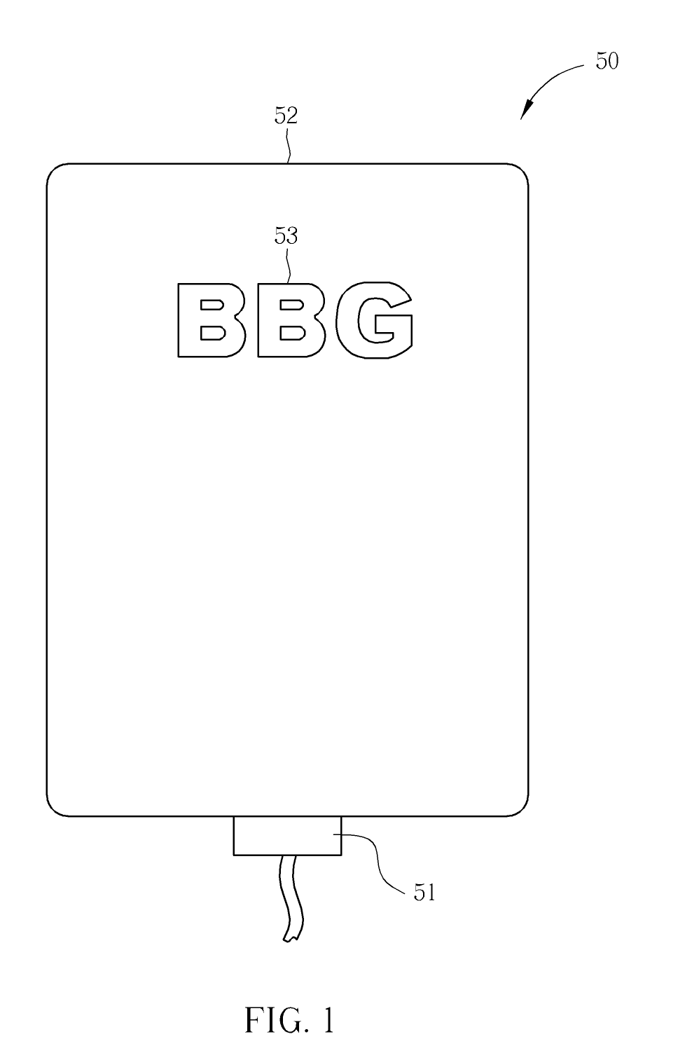

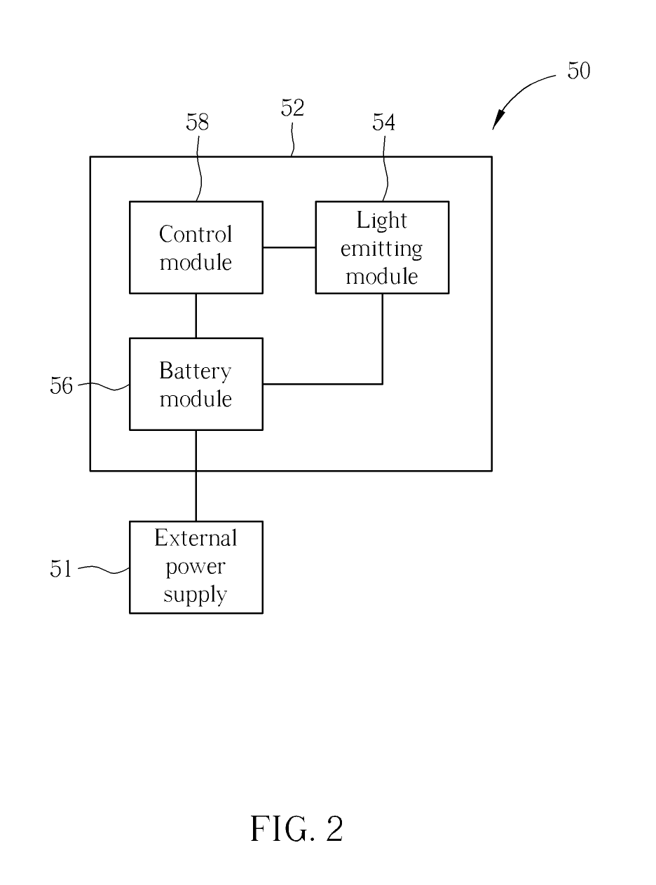

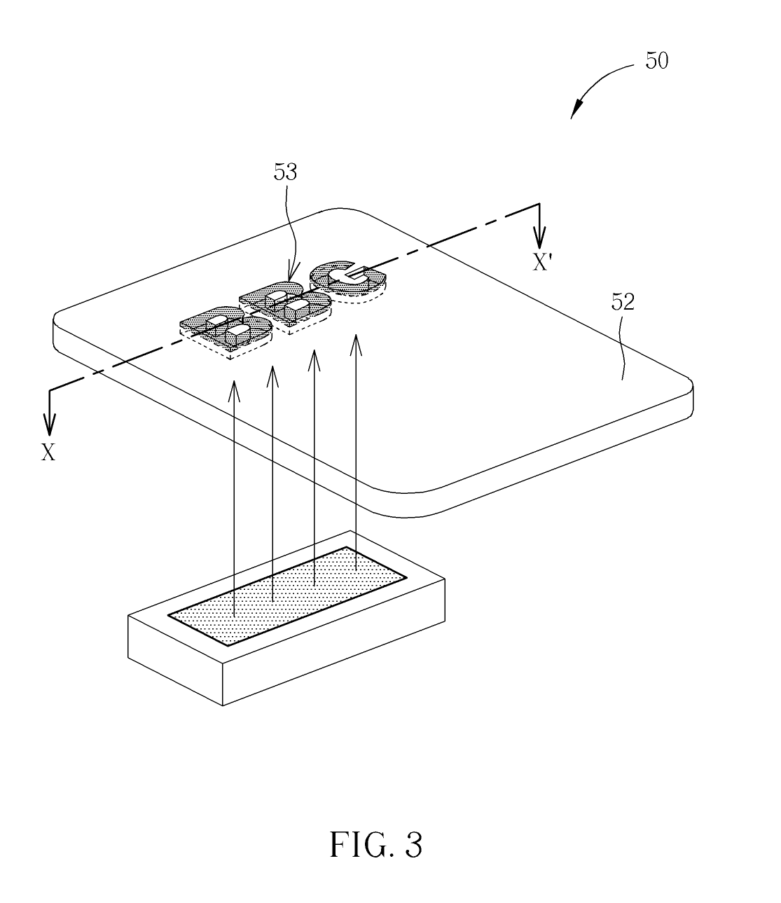

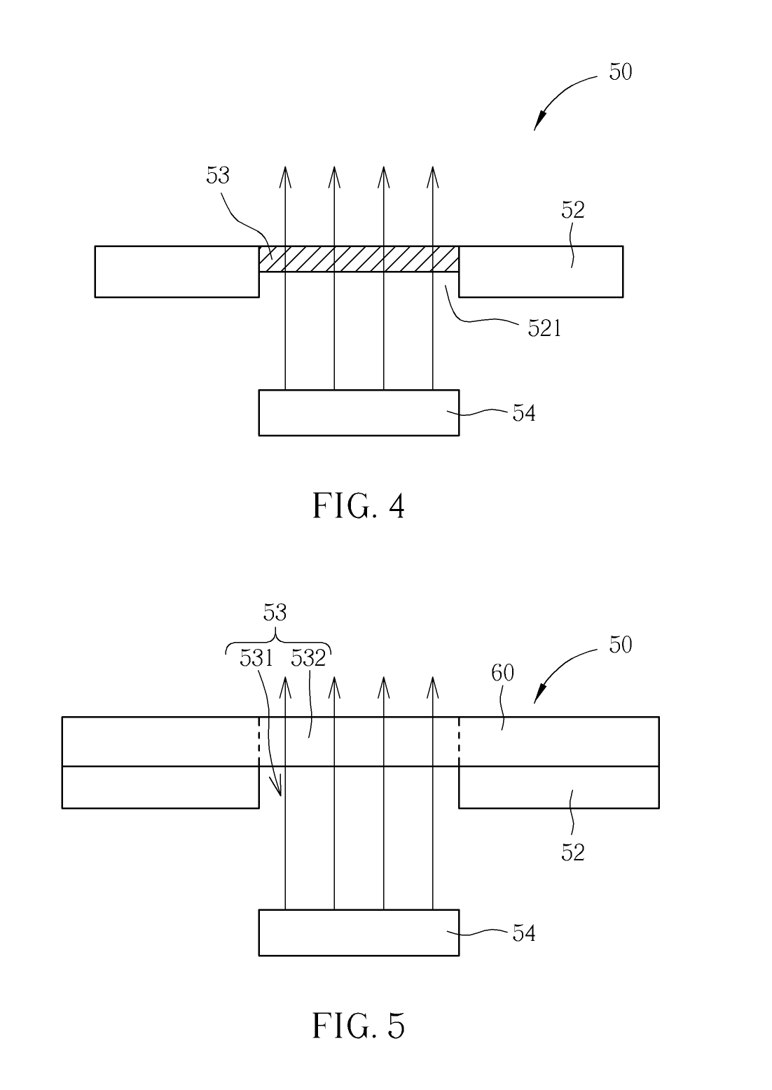

Please refer to FIG. 1 and FIG. 2 . FIG. 1 is a diagram illustrating that an electronic device 50 is being charged according to an embodiment of the present invention. FIG. 2 is a block diagram of the electronic device 50 electrically connected to an external power supply 51 according to the embodiment of the present invention. The electronic device 50 can be a smartphone, a tablet computer or a smart TV. The electronic device 50 includes a casing 52, a light penetrating portion 53, a light emitting module 54, a battery module 56 and a control module 58. Please refer to FIG. 1 to FIG. 4. FIG. 3 is a partial diagram of the electronic device 50 according to the embodiment of the present invention. FIG. 4 is a sectional view of the electronic device 50 along a line X-X′ in FIG. 3 according to the embodiment of the present invention. As shown in FIG. 4, an hole 521 is formed on the casing 52, and the light penetrating portion 53 is disposed inside the hole 521. The hole 521 of the casing 52 and the light penetrating portion 53 can be on any position of the casing 52, such as being on a rear surface, a front surface or a lateral surface of the casing 52. The hole 521 and the light penetrating portion 53 can be formed as a text pattern or a graphic pattern, respectively. For example, the hole 521 and the light penetrating portion 53 can be respectively formed as a logo pattern as shown in FIG. 1. The casing 52 can be made of metal materials, and the light penetrating portion 53 can be made of a transparent material, such as glass or transparent plastic. The materials of the casing 52 and the light penetrating portion 53 are not limited to this embodiment and depend on practical design demands. The light emitting module 54 is disposed inside the casing 52 and on a position corresponding to the light penetrating portion 53. The light emitting module 54 is for emitting light to pass through the light penetrating portion 53 and then outside the casing 52, so as to represent a light shape corresponding to the text pattern or the graphic pattern. A color of the light penetrating portion 53 can be designed to be the same with or similar with a color of the casing 52, so that the text pattern or the graphic pattern formed by the light penetrating portion 53 cannot be presented as the light emitting module 54 does not emit the light. Only when the light emitting module 54 emits the light to pass through the light penetrating portion 53 and then outside the casing 52, the text pattern or the graphic pattern formed by the light penetrating portion 53 can be presented.

As shown in FIG. 2, the battery module 56 is disposed inside the casing 52 and electrically connected to the control module 58 and the light emitting module 54. That is, the battery module 56 is for providing internal components of the electronic device 50 with electricity, so that the electronic device 50 is able to execute functions for a user. The external power supply 51 can be electrically connected to the battery module 56, and the external electrical power supply 51 charges the battery module 56 by a cable or wireless. That is, any ways for charging the battery module 56 are within the scope of the present invention. The control module 58 is disposed inside the casing 52 and electrically connected to the battery module 56 and the light emitting module 54. As the external electrical power supply 51 charges the battery module 56, the control module 58 is for controlling the light emitting module 54 to emit the light to pass through the light penetrating portion 53 and then outside the casing 52, so as to notify the user that the electronic device 50 is in a charging state. Moreover, the control module 58 can control the light emitting module 54 to continuously emit different light according to a capacity ratio of a current electrical capacity to a full electrical capacity of the battery module 56, so as to generate different notification messages corresponding to the current electrical capacity of the battery module 56 continuously. In addition, as the electronic device 50 is turned off or standby and the battery module 56 is electrically connected to the external electrical power 51, the control module 58 is still for controlling the light emitting module 54 to emit the notification message.

In this embodiment, the notification message can be a flashing message with a flashing frequency corresponding to the capacity ratio. For example, as the capacity ratio corresponds to a low capacity ratio, such as 10%, the control module 58 is for controlling the light emitting module 54 to emit the flashing message with a low flashing frequency, such as 10 Hz. That is, the text pattern “BBG” flashes one time in 0.1 second, but is not limited to it. For example, it can flash two times in 0.1 second. As the capacity ratio increases gradually, such as increasing from 10% to 60%, the control module 58 gradually increases the flashing frequency according to the capacity ratio, such as increasing the flashing frequency from 10 Hz to 60 Hz. Therefore, it can determine that the current electrical capacity of the battery module 56 is high or low by different flashing frequencies. In this embodiment, the low flashing frequency corresponds to the low capacity ratio, and a high flashing frequency corresponds to a high capacity ratio, but is not limited to this embodiment. For example, it can be designed that the low flashing frequency corresponds to the high capacity ratio, and the high flashing frequency corresponds to the low capacity ratio.

Furthermore, it is noticed that the control module 58 increases the flashing frequency gradually and proportionally according to the capacity ratio in this embodiment. That is, a relationship between the capacity ratio and the flashing frequency is a linear function. However, ways for increasing the flashing frequency by the control module 58 are not limited to this embodiment. For example, the relationship between the capacity ratio and the flashing frequency can be designed to be an exponential function. As the current electrical capacity of the battery module 56 is the full electrical capacity and the battery module 56 is electrically connected to the external electrical power supply 51, that is, the capacity ratio is 100%, the control module 58 is for controlling the light emitting module 54 not to emit the light or to emit continuous light selectively, so as to notify that the electronic device 50 is charged completely.

Moreover, in another embodiment, the notification message can be designed to be a bright message with brightness corresponding to the capacity ratio of the battery module 56. For example, as the capacity ratio of the battery module 56 is the low capacity ratio, such as 10%, the control module 58 is for controlling the light emitting module 54 to emit the bright message with low brightness, such as 100 lm. As the capacity ratio increases gradually, such as increasing from 10% to 60%, the control module 58 gradually increases the brightness according to the capacity ratio, such as increasing the brightness from 100 lm to 350 lm. Therefore, it can determine that the current electrical capacity of the battery module 56 is high or low by different brightness. Similarly, in this embodiment, the low brightness corresponds to the low capacity ratio, and a high brightness corresponds to the high capacity ratio, but is not limited to this embodiment. For example, it can be designed that the high brightness corresponds to the low capacity ratio, and the low brightness corresponds to the high capacity ratio.

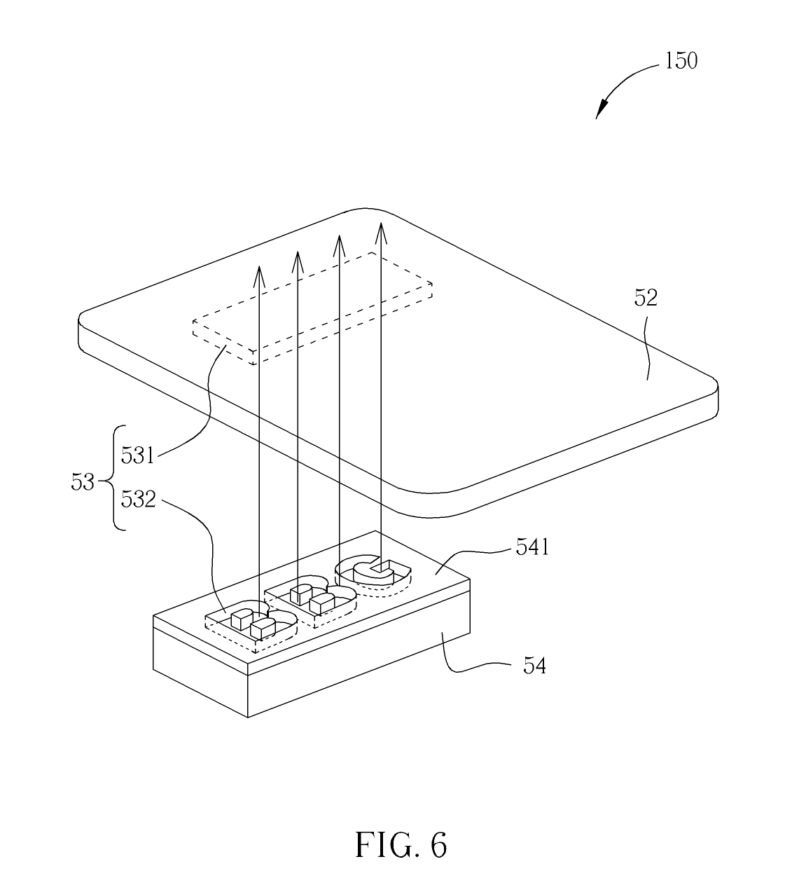

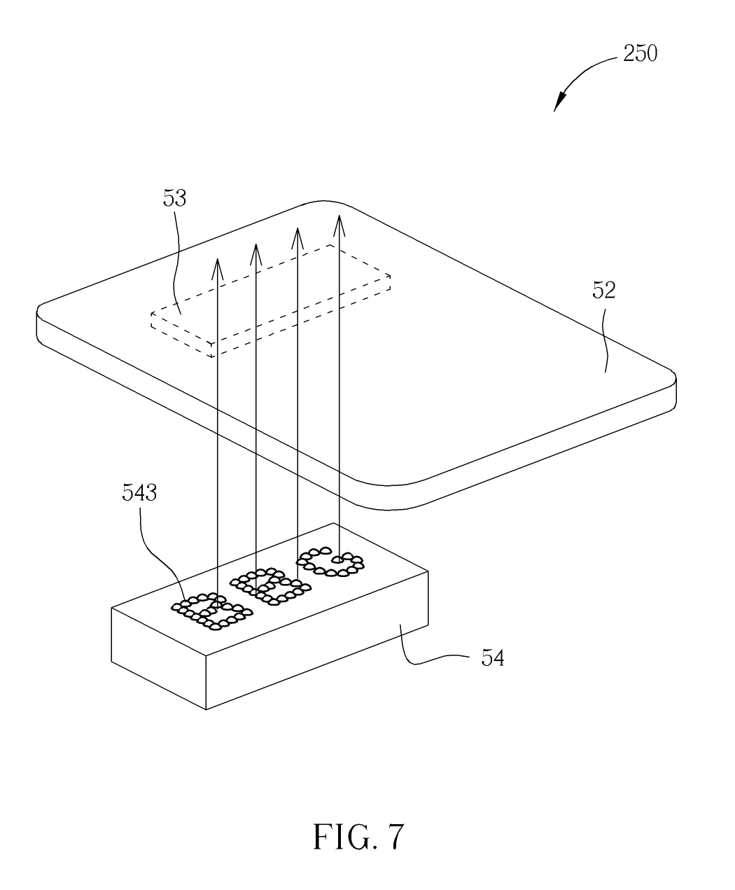

Please refer to FIG. 2 and FIG. 5. FIG. 5 is a sectional view of the electronic device 50 according to another embodiment of the present invention. In this embodiment, the electronic device 50 can further include a protecting layer 60 disposed on the casing 52. The protecting layer 60 is made of a transparent material, such as protecting glass or a paint layer, so as to protect the electronic device 50 from being damaged. The light penetrating portion 53 includes a first penetrating area 531 in the casing 52 and a second penetrating area 532 in the protecting layer 60. As the external electrical power supply 51 charges the battery module 56, the control module 58 is for controlling the light emitting module 54 to emit the light to pass through the first penetrating area 531 and second penetrating area 532 in sequence and then outside the casing 52, so as to generate the different notification messages. A structural design in this embodiment is for improving the appearance of the electronic device 50. The notification message in this embodiment can be the flashing message or the bright message, and an operational principle in this embodiment is same as the operational principle in the previous embodiment, so that it is omitted herein. In addition, please refer to FIG. 2 and FIG. 6. FIG. 6 is a diagram of an electronic device 150 according to another embodiment of the present invention. In this embodiment, the first penetrating area 531 of the light penetrating portion 53 is in the casing 52, and the second penetrating area 532 is on a cover 541 of the light emitting module 54. In this structural design, the text pattern or the graphic pattern formed on the second penetrating area 532 is disposed on the light emitting module 54 directly, so as to reduce the complexity in the manufacturing process. The notification message in this embodiment can be the flashing message or the bright message, and an operational principle in this embodiment is same as the operational principle in the previous embodiment, so that it is omitted herein.

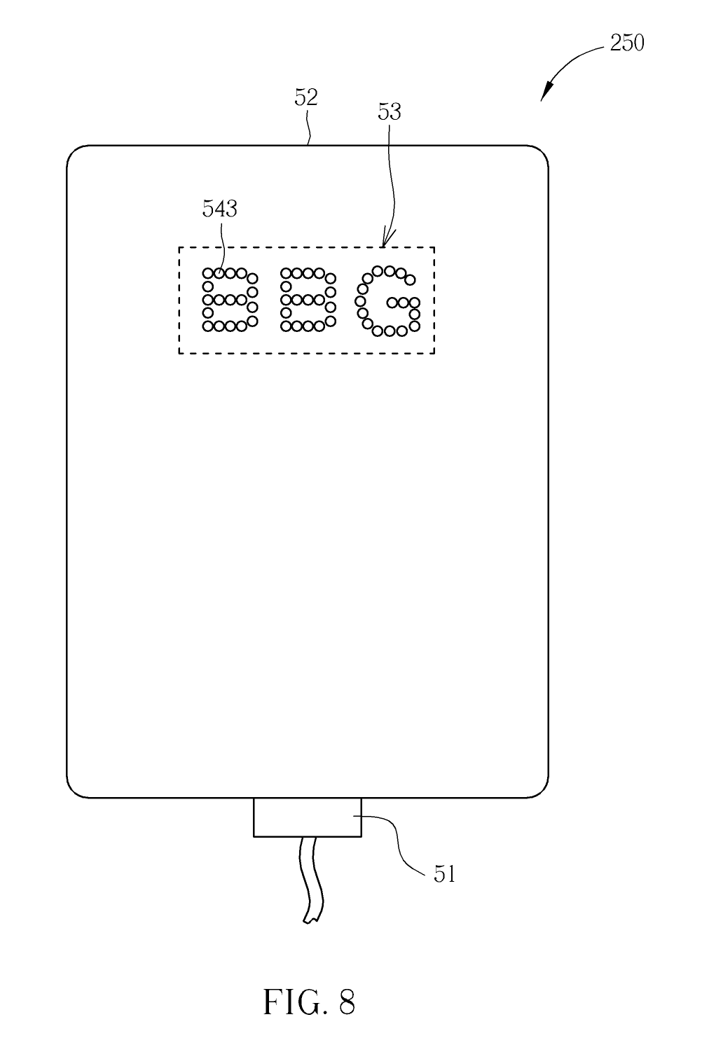

Please refer to FIG. 2, FIG. 7 and FIG. 8. FIG. 7 and FIG. 8 are respectively a diagram and a top view of an electronic device 250 according to another embodiment of the present invention. In this embodiment, the light penetrating portion 53 is a transparent area on the casing 52. The light emitting module 54 includes a plurality of light emitting components 543. The plurality of light emitting components 543 can be a plurality of LEDs and can be arranged as the text pattern or the graphic pattern, such as being arranged as the text pattern “BBG” shown in FIG. 7 and FIG. 8. The control module 58 is for controlling different numbers of the plurality of light emitting components 543 to emit the light to pass through the light penetrating portion 53 and then outside the casing 52 according to the capacity ratio, so as to generate the different notification messages. For example, as the capacity ratio is 30%, the control module 58 can only control the light emitting components 543 consisting of the first letter “B” to emit the light. As the capacity ratio increases from 30% to 60%, the control module 58 can control the light emitting components 543 consisting of the first letter “B” and the second letter “B” to emit the light simultaneously. Therefore, it can determine that the current electrical capacity of the battery module 56 is high or low according to the number of the light emitting components 543 emitting the light. A relationship between the capacity ratio and the number of the light emitting components 543 controlled by the control module 58 to emit the light is not limited to above embodiment, and it depends on practical design demands. Besides, the control module 58 can also be designed to control the light emitting components 543 to emit the flashing message or the bright message, and an operational principle in this embodiment is same as the operational principle in the previous embodiments, so that it is omitted herein.

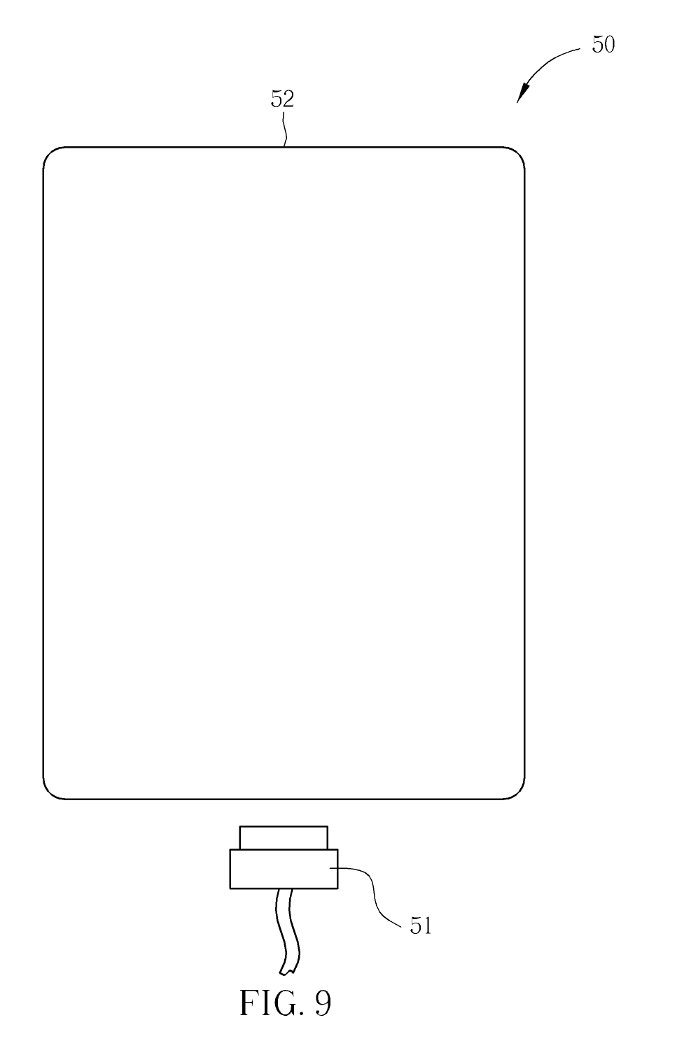

Please refer to FIG. 2 and FIG. 9 . FIG. 9 is a diagram illustrating that the external power supply 51 is not connected to the electronic device 50 according to the embodiment of the present invention. In any embodiments of the present invention, the electronic device can be designed that when the external power supply 51 is removed and is not electrically connected to the battery module 56, that is, the external power supply 51 does not charge the battery module 56 of the electronic device 50, the control module 58 does not control the light emitting module 54 to emit the light, so as to prevent the electronic device 50 from wasting the unnecessary electricity.

In contrast to the prior art, the control module in the present invention is designed to continuously control the light emitting module to emit the light with variable frequency or variable brightness whenever the external power supply charges the battery module, so as to generate the different notification messages to notify the user of the current electrical capacity. Therefore, it solves the conventional problems that the user has to wake up the electronic device to show the charging state on screen of the electronic device. In addition, the control module can also be designed not to control the light emitting module to emit the light when the external power supply does not charge the battery module. Moreover, the color of the light penetrating portion can be designed to be the same with or similar with the color of the casing, so that the text pattern or the graphic pattern formed by the light penetrating portion is not presented as the light emitting module does not emit the light, so as to maintain uniformity of the overall appearance of the electronic device. As a result, it also solves the conventional problem that the LED disposed in a hole on the casing affects uniformity of the overall appearance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A electronic device, comprising:
a casing;
a light emitting module disposed inside the casing;
a light penetrating portion wherethrough light emitted from the light emitting module passes;
a battery module disposed inside the casing; and
a control module disposed inside the casing and electrically connected to the battery module and the light emitting module, the control module being for controlling the light emitting module to emit different light to pass through the light penetrating portion and outside the casing according to a capacity ratio of a current electrical capacity to a full electrical capacity of the battery module as an external electrical power supply charges the battery module, so as to generate different notification messages corresponding to the current electrical capacity of the battery module.

2. The electronic device of claim 1, wherein the external electrical power supply charges the battery module by a cable or wireless.

3. The electronic device of claim 2, wherein the notification message is a flashing message with a flashing frequency corresponding to the capacity ratio.

4. The electronic device of claim 2, wherein the notification message is a bright message with brightness corresponding to the capacity ratio.

5. The electronic device of claim 1, wherein the light penetrating portion is a text pattern or a graphic pattern.

6. The electronic device of claim 5, wherein the notification message is a flashing message with a flashing frequency corresponding to the capacity ratio.

7. The electronic device of claim 5, wherein the notification message is a bright message with brightness corresponding to the capacity ratio.

8. The electronic device of claim 1, wherein the light emitting module comprises a plurality of light emitting components arranged in a text pattern or a graphic pattern, and the control module is for controlling different numbers of the plurality of light emitting components to emit light to pass through the light penetrating portion and outside the casing according to the capacity ratio.

9. The electronic device of claim 8, wherein the notification message is a flashing message with a flashing frequency corresponding to the capacity ratio.

10. The electronic device of claim 8, wherein the notification message is a bright message with brightness corresponding to the capacity ratio.

11. The electronic device of claim 1, wherein the notification message is a flashing message with a flashing frequency corresponding to the capacity ratio.

12. The electronic device of claim 11, wherein as the capacity ratio corresponds to a low capacity ratio, the control module is for controlling the light emitting module to emit the flashing message with a low flashing frequency, and as the capacity ratio increases gradually, the control module gradually increases the flashing frequency according to the increasing capacity ratio.

13. The electronic device of claim 1, wherein the notification message is a bright message with brightness corresponding to the capacity ratio.

14. The electronic device of claim 13, wherein as the capacity ratio corresponds to a low capacity ratio, the control module is for controlling the light emitting module to emit the bright message with low brightness, and as the capacity ratio increases gradually, the control module gradually increases the brightness according to the increasing capacity ratio.

15. The electronic device of claim 1, wherein as the current electrical capacity is the full electrical capacity and the battery module is electrically connected to the external electrical power supply, the control module is for controlling the light emitting module not to emit the light or to emit continuous light selectively.

16. The electronic device of claim 1, wherein as the electronic device is turned off or standby and the battery module is electrically connected to the external electrical power, the control module is for controlling the light emitting module to emit the notification message.

17. The electronic device of claim 1, wherein a hole is formed on the casing, and the light penetrating portion is disposed inside the hole.

18. The electronic device of claim 1, further comprising a protecting layer disposed on the casing, the protecting layer being made of a transparent material, and the light penetrating portion comprising a first penetrating area in the casing and a second penetrating area in the protecting layer.

19. The electronic device of claim 1, wherein the light penetrating portion comprises a first penetrating area in the casing and a second penetrating area on a cover of the light emitting module.
